(19) United States
(12) Patent Application Publication
(10) Pub. No.: US 2005/0010761 A1
(43) Pub. Date: Jan. 13, 2005

(54) High performance security policy database cache for network processing

(76) Inventors: Alwyn Dos Remedios, Markham (CA); Wajdi K. Feghali, Ottawa (CA); Gilbert Wolrich, Framingham, MA (US); Bradley Burres, Cambridge, MA (US)

Correspondence Address: FISH & RICHARDSON P.C., Suite 500, 4350 La Jolla Village Druve, San Diego, CA, 92122, US

(21) Appl. No.: 10/618,576

(22) Filed: Jul. 11, 2003

(51) Int. Cl. H04L 9/00

(52) U.S. Cl. 713/164; 713/176

(57) ABSTRACT

A security policy database cache includes at least one primary table including signature values that indicate that a packet's security policy database information may be in the cache and at least one secondary table including cache entries having a selector, flags, security association information and an operation to perform on the corresponding packet for which a cache lookup was made.

### BACKGROUND

The IPsec standard promulgated by The Network Working Group of The Internet Society, Inc. requires that a security policy database (SPD) be consulted for each packet that traverses an IPsec enabled device. As the number of secure tunnels increases, the amount of searching required to locate a correct SPD entry in the security policy database grows substantially. This causes a huge strain on network packet processing. Also, as the speed of network transmissions increase, the amount of time permitted to search the database decreases.

### DESCRIPTION OF DRAWINGS

FIG. 1 is a block diagram of a network processor.

FIGS. 2A-2D are block diagrams of a microengine used in the network processor of FIG. 1.

FIG. 3 is a block diagram of a cache structure.

FIG. 4 is a block diagram of an alternative cache structure.

FIG. 5 is a flow chart of inbound packet processing.

FIG. 6 is a flow chart of outbound packet processing.

FIGS. 7A and 7B are a flow chart of process to populate the cache structure.

### DETAILED DESCRIPTION

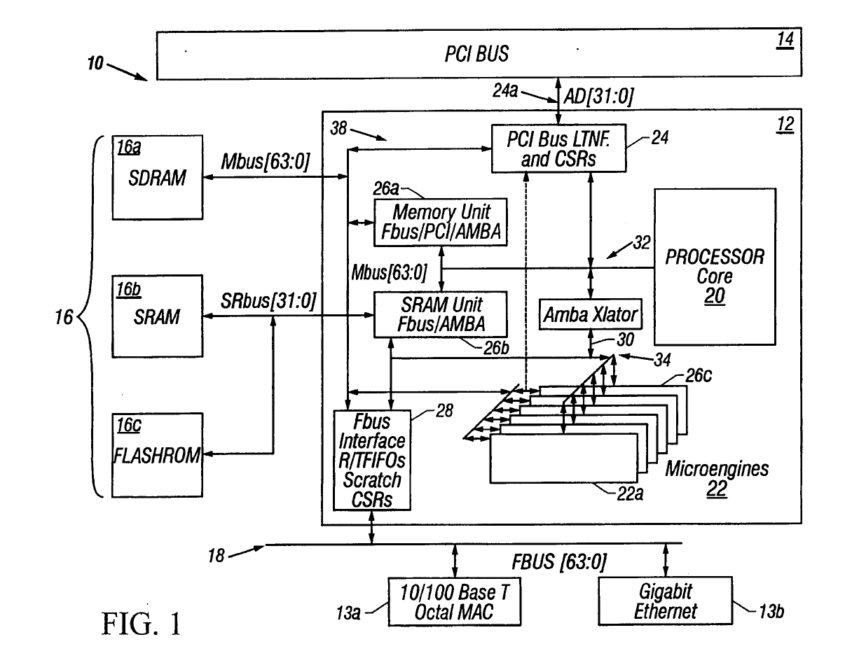

Referring to FIG. 1, a communication system 10 includes a parallel, hardware-based multithreaded processor 12. The hardware-based multithreaded processor 12 is coupled to a bus such as a PCI bus 14, a memory system 16 and a second bus 18. The system 10 is especially useful for tasks that can be broken into parallel subtasks or functions. Specifically hardware-based multithreaded processor 12 is useful for tasks that are bandwidth oriented rather than latency oriented. The hardware-based multithreaded processor 12 has multiple microengines 22 each with multiple hardware controlled threads that can be simultaneously active and independently work on a task.

The hardware-based multithreaded processor 12 also includes a central controller 20 that assists in loading microcode control for other resources of the hardware-based multithreaded processor 12 and performs other general-purpose computer type functions such as handling protocols, exceptions, and extra support for packet processing where the microengines pass the packets off for more detailed processing such as in boundary conditions. In one embodiment, the processor 20 is a Strong Arm® (Arm is a trademark of ARM Limited, United Kingdom) based architecture. The general-purpose microprocessor 20 has an operating system. Through the operating system the processor 20 can call functions to operate on microengines 22a-22f. The processor 20 can use any supported operating system preferably a real time operating system. For the core processor implemented as Strong Arm architecture, operating systems such as, MicrosoftNT Real-Time, VXWorks and μCUS, a freeware operating system available over the Internet, can be used.

The hardware-based multithreaded processor 12 also includes a plurality of function microengines 22a-22f. Functional microengines (microengines) 22a-22f each maintain a plurality of program counters in hardware and states associated with the program counters. Effectively, a corresponding plurality of sets of threads can be simultaneously active on each of the microengines 22a-22f while only one is actually operating at any one time.

In one embodiment, there are, e.g., six microengines 22a-22f as shown. Microengines can sometimes be referred to as packet engines, when used to process packets. Each microengines 22a-22f has capabilities for processing four hardware threads. The six microengines 22a-22f operate with shared resources including memory system 16 and bus interfaces 24 and 28. The memory system 16 includes a Synchronous Dynamic Random Access Memory (SDRAM) controller 26a and a Static Random Access Memory (SRAM) controller 26b. SDRAM memory 16a and SDRAM controller 26a are typically used for processing large volumes of data, e.g., processing of network payloads from network packets. The SRAM controller 26b and SRAM memory 16b are used in a networking implementation for low latency, fast access tasks, e.g., accessing look-up tables, memory for the core processor 20, and so forth.

The six microengines 22a-22f access either the SDRAM 16a or SRAM 16b based on characteristics of the data. Thus, low latency, low bandwidth data is stored in and fetched from SRAM, whereas higher bandwidth data for which latency is not as important, is stored in and fetched from SDRAM. The microengines 22a-22f can execute memory reference instructions to either the SDRAM controller 26a or SRAM controller 16b.

One example of an application for the hardware-based multithreaded processor 12 is as a network processor. As a network processor, the hardware-based multithreaded processor 12 interfaces to network devices such as a media access controller device e.g., a 10/100BaseT Octal MAC 13a or a Gigabit Ethernet device 13b and a security policy database (SPD) 55 stored in memory (either SRAM or SDRAM). In some embodiments, a network-forwarding device would also include a framer and a switching fabric. In general, as a network processor, the hardware-based multithreaded processor 12 can interface to any type of communication device or interface that receives/sends large amounts of data. Communication system 10 functioning in a networking application could receive a plurality of network packets from the devices 13a, 13b and process those packets in a parallel manner. With the hardware-based multithreaded processor 12, each network packet can be independently processed.

In the arrangement shown in FIG. 1, the network processor is part of a network router, but could also be used in a network interface device, switch, and other types of applications. The processor 12 includes a bus interface 28 that couples the processor to the second bus 18. Bus interface 28 in one embodiment couples the processor 12 to the so-called FBUS 18 (FIFO bus). The FBUS interface 28 is responsible for controlling and interfacing the processor 12 to the FBUS 18. The FBUS 18 is a 64-bit wide FIFO bus, used to interface to Media Access Controller (MAC) devices.

The processor 12 includes a second interface e.g., a PCI bus interface 24 that couples other system components that reside on the PCI 14 bus to the processor 12. The PCI bus interface 24, provides a high speed data path 24a to memory 16 e.g., the SDRAM memory 16a. Through that path data can be moved quickly from the SDRAM 16a through the PCI bus 14, via direct memory access (DMA) transfers. The hardware based multithreaded processor 12 supports image transfers. The hardware based multithreaded processor 12 can employ a plurality of DMA channels so if one target of a DMA transfer is busy, another one of the DMA channels can take over the PCI bus to deliver information to another target to maintain high processor 12 efficiency. Additionally, the PCI bus interface 24 supports target and master operations. Target operations are operations where slave devices on bus 14 access SDRAMs through reads and writes that are serviced as a slave to target operation. In master operations, the processor core 20 sends data directly to or receives data directly from the PCI interface 24.

Each of the functional units are coupled to one or more internal buses. As described below, the internal buses are dual, 32 bit buses (i.e., one bus for read and one for write). The hardware-based multithreaded processor 12 also is constructed such that the sum of the bandwidths of the internal buses in the processor 12 exceed the bandwidth of external buses coupled to the processor 12. The processor 12 includes an internal core processor bus 32, e.g., an ASB bus (Advanced System Bus) that couples the processor core 20 to the memory controller 26a, 26c and to an ASB translator 30 described below. The ASB bus is a subset of the so-called AMBA bus that is used with the Strong Arm processor core. The processor 12 also includes a private bus 34 that couples the microengine units to SRAM controller 26b, ASB translator 30 and FBUS interface 28. A memory bus 38 couples the memory controller 26a, 26b to the bus interfaces 24 and 28 and memory system 16 including flashrom 16c used for boot operations and so forth.

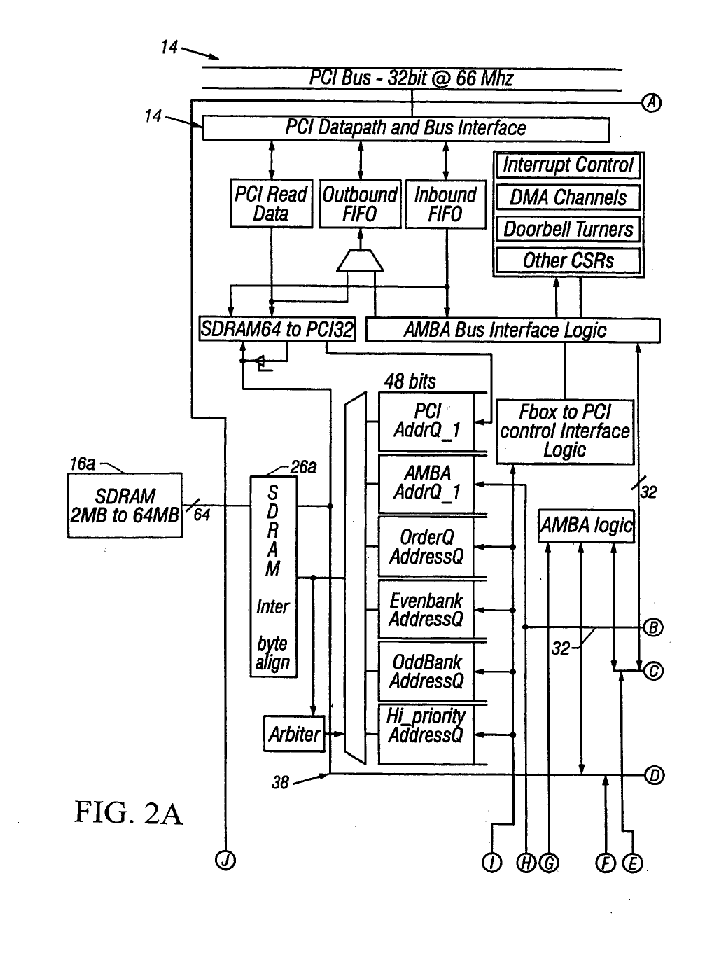

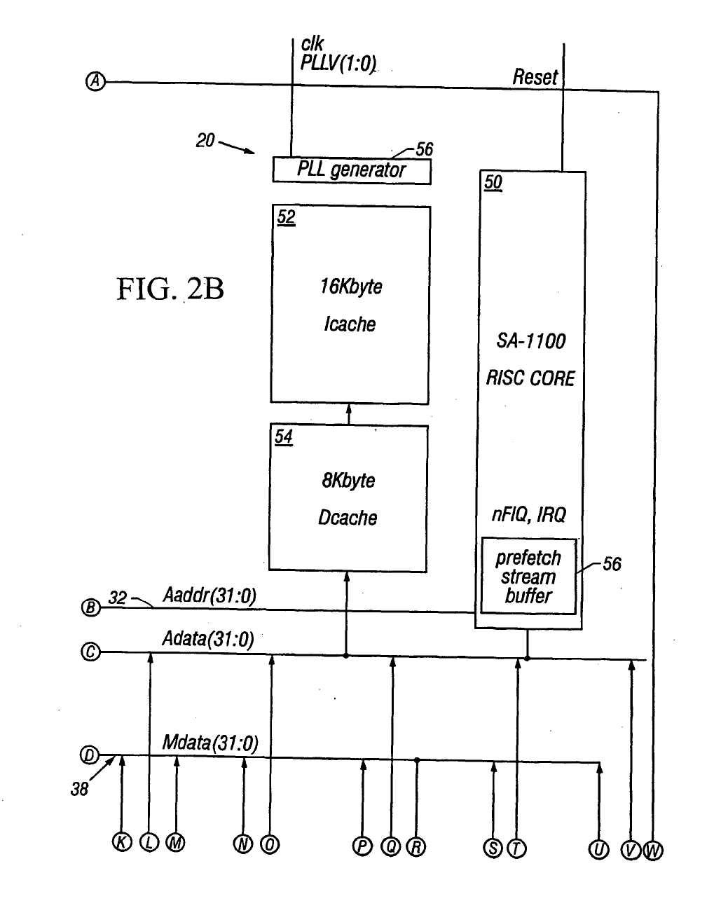

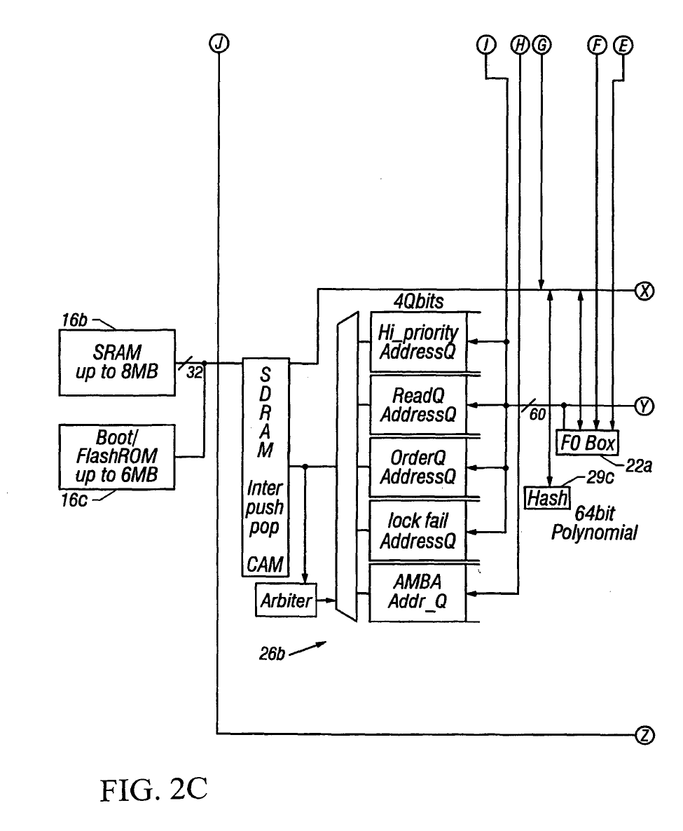

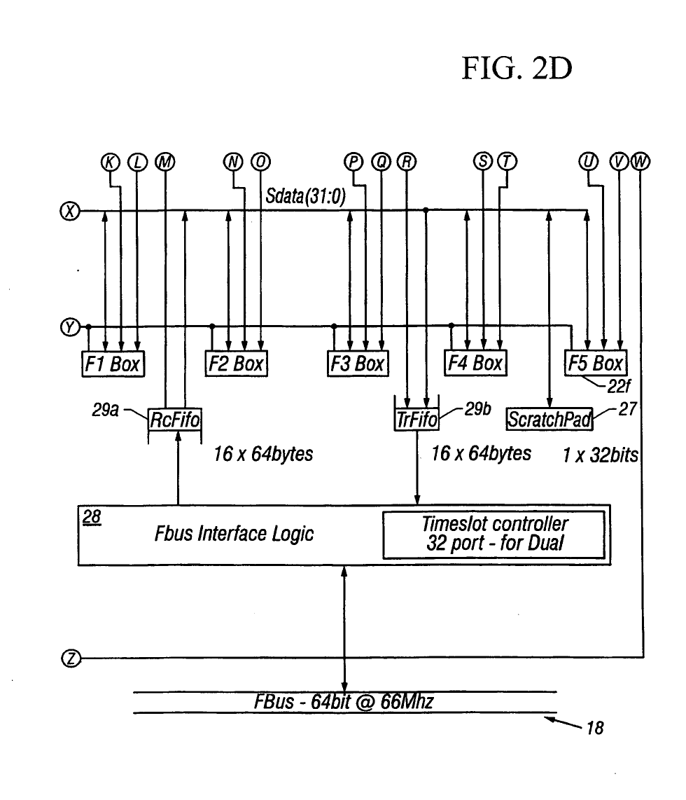

Referring to FIGS. 2A-2D, each of the microengines 22a-22f includes an arbiter that examines flags to determine the available threads to be operated upon. Any thread from any of the microengines 22a-22f can access the SDRAM controller 26a, SDRAM controller 26b or FBUS interface 28. The memory controllers 26a and 26b each include a plurality of queues to store outstanding memory reference requests. The queues either maintain order of memory references or arrange memory references to optimize memory bandwidth. For example, if a thread_{—}0 has no dependencies or relationship to a thread_{—}1, there is no reason that thread 1 and 0 cannot complete their memory references to the SRAM unit out of order. The microengines 22a-22f issue memory reference requests to the memory controllers 26a and 26b. The microengines 22a-22f flood the memory subsystems 26a and 26b with enough memory reference operations such that the memory subsystems 26a and 26b become the bottleneck for processor 12 operation.

Data functions are distributed amongst the microengines. The data buses, e.g., ASB bus 30, SRAM bus 34 and SDRAM bus 38 coupling shared resources, e.g., memory controllers 26a and 26b are of sufficient bandwidth such that there are no internal bottlenecks. As an example, the SDRAM can run a 64 bit wide bus. The SRAM data bus could have separate read and write buses, e.g., could be a read bus of 32 bits wide running at 166 MHz and a write bus of 32 bits wide at 166 MHz.

The core processor 20 also can access the shared resources. The core processor 20 has a direct communication to the SDRAM controller 26a to the bus interface 24 and to SRAM controller 26b via bus 32. However, to access the microengines 22a-22f and transfer registers located at any of the microengines 22a-22f, the core processor 20 accesses the microengines 22a-22f via the ASB Translator 30 over bus 34. The ASB translator 30 can physically reside in the FBUS interface 28, but logically is distinct. The ASB Translator 30 performs an address translation between FBUS microengine transfer register locations and core processor addresses (i.e., ASB bus) so that the core processor 20 can access registers belonging to the microengines 22a-22c.

Although microengines 22 can use the register set to exchange data as described below, a scratchpad memory 27 is also provided to permit microengines to write data out to the memory for other microengines to read. The scratchpad 27 is coupled to bus 34.

The processor core 20 includes a RISC core 50 implemented in a five stage pipeline performing a single cycle shift of one operand or two operands in a single cycle, provides multiplication support and 32 bit barrel shift support. This RISC core 50 is a standard Strong Arm® architecture but it is implemented with a five stage pipeline for performance reasons. The processor core 20 also includes a 16 kilobyte instruction cache 52, an 8 kilobyte data cache 54 and a prefetch stream buffer 56. The core processor 20 performs arithmetic operations in parallel with memory writes and instruction fetches. The core processor 20 interfaces with other functional units via the ARM defined ASB bus. The ASB bus is a 32-bit bi-directional bus 32.

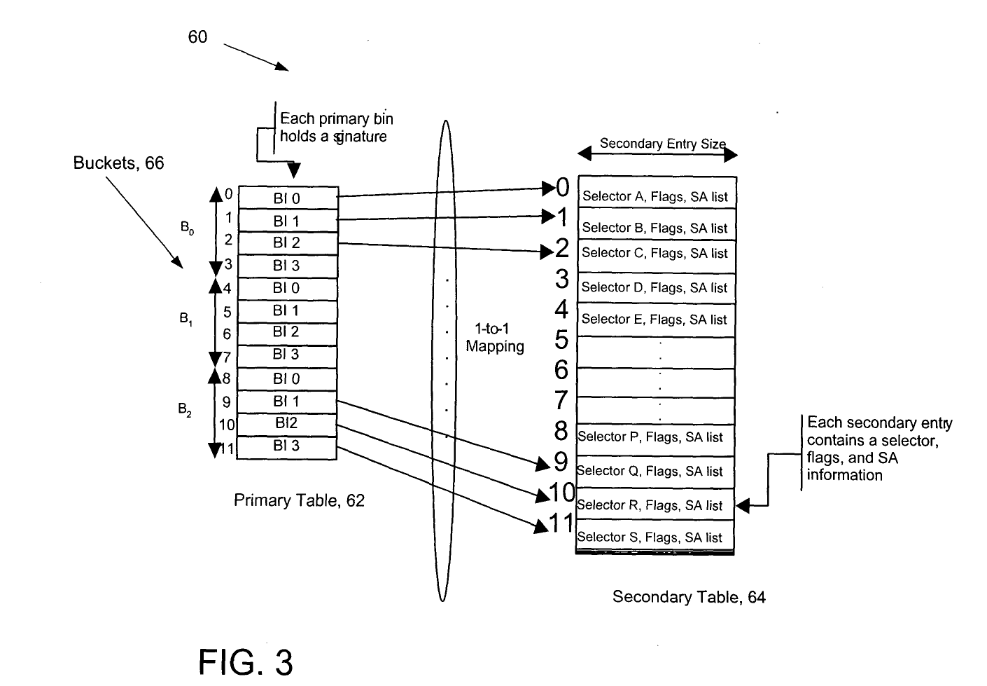

Referring to FIG. 3, a security policy database (SPD) cache 60 includes a primary table and a secondary table. The security policy database cache is interposed to allow the network processor 12 to retrieve security policies for processing of network packets, in a faster and more efficient manner than attempting to secure those policies from the security policy database. The primary table 62 has signatures, which are values that indicate whether security policy database 55 (SPD) information for packets maybe in the cache. The secondary table 64 includes a full cache entry. The full cache entry includes a selector, optional flags that can be associated with a packet, security association information (SA information) and an operation (e.g., drop, bypass or apply, exception or unknown) to perform on the corresponding packet for which a cache lookup was made.

In one embodiment, the primary tables 62 reside in DRAM whereas, the secondary tables reside in SDRAM. Alternatively, the tables can reside in the same memory or can reside in scratchpad or a dedicated memory structure. In addition, the process to manage these tables can be executed in the microengines 22 or alternatively in the core processor 20.

Each primary table 62 is divided into a plurality of buckets, 66 B₀-B₃ and each bucket B₀-B₃ is subdivided into bins B₁₀-B₁₃, as shown. The number of entries in a primary table is equal to the number of bins per bucket times the number of buckets. In this arrangement, the cache has a one-to-one relationship between a primary table element's BᵢBIⱼ (Bucketᵢ, Binⱼ) location or index, and a secondary table 64 element's location Sₖ or index. For example, the fifth element B₁BI₀ in the primary table 62 will always be associated with the fifth element S₄ in the secondary table 64. The primary and secondary table relationship is thus defined by this one to one relationship. Other relationships are possible. In the example of FIG. 3 the primary table has 3 buckets and each bucket has 4 bins.

The signature (S), index for the first primary table (L1) and index for the second primary table (L2) are produced using an IP selector and either a hardware hash unit included in the network processor 12 or a software hashing algorithm that executes on the microengine or core processor. The IP selector can be either IPv4 or IPv6, (IP packet levels 4 or 6). An IP selector is defined in RFC 2401 (RFC 2401 Network Working Group of The Internet Society, Inc.) to be a set of IP and upper layer protocol field values that is used by the security policy database to map traffic to a policy and includes IP destination, IP source, IP protocol, IP source port, and IP destination port. The IP source and destination ports are used for those protocols that contain ports. Secondary table entries include selector, flags and SA information as shown.

In general, the Security Policy Database Caches 60 can have N primary tables and N secondary tables (where N is a positive, whole number).

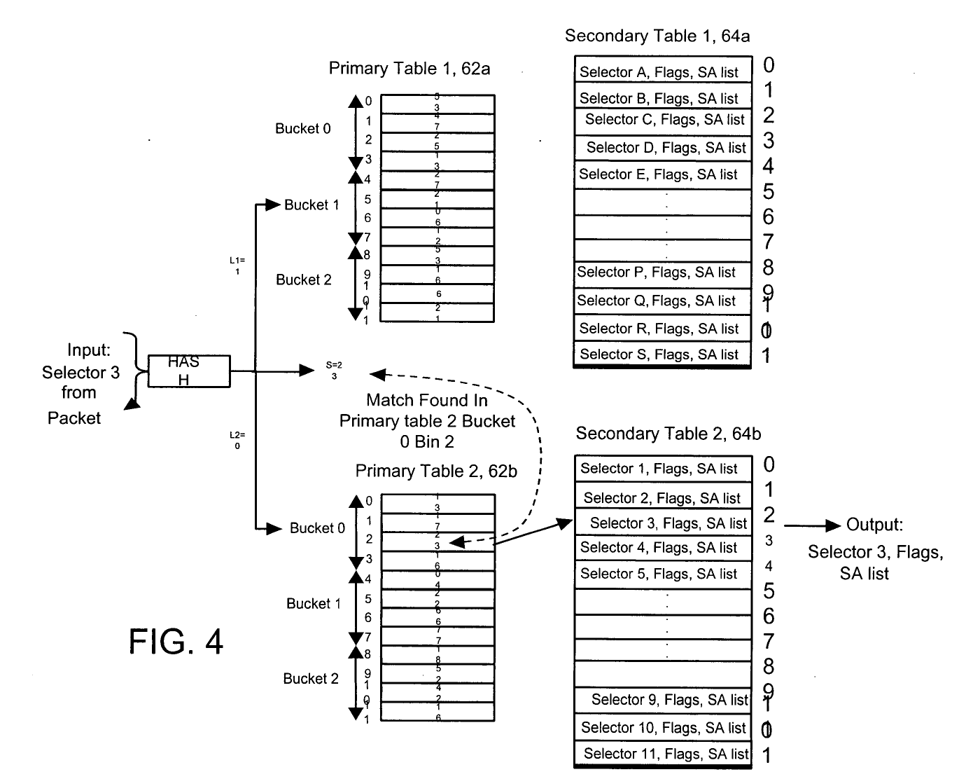

Referring to FIG. 4, an example using 2 primary tables 62a and 62b and two corresponding secondary tables 64a and 64b is shown. “Input selector 3” is provided from a packet and is hashed (using either a hardware hash unit or a software hashing algorithm, as mentioned above). From the hash of input selector 3 to produce an index for table 62a of L1=1 and an index for table 62b of L2=0. The hash of the input selector also produces a signature S=23 corresponding to the second table entry selector 3 flags. If this signature or tag is found in the primary table, then there is a chance that the selector is in the secondary table. Once the secondary table at the same index L1 or L2 is read, it will test conclusively if the signature match was a real match for the selector or if two separate selectors happened to produce the same S value. When bucket 1 in primary table 62a (table one) is searched, no matching signature is found so the secondary table 64a for primary table 62a is never accessed. When bucket 0 in primary table 62b is read, the signature “23” is found at bucket 0 bin location 2. This corresponds to a match. Therefore, the secondary table 64b associated with primary table 62a is read and the selector 3 is compared with the selector 3 from the packet. Since the selector match is successful, the flags and SA list are successfully returned to the requesting microengine.

For outbound packets, the SPD 60 cache is used to determine the operation to apply to the packet. The operations can either be “apply IPsec security”, “discard” or “bypass IPsec” (refer to RFC 2401 Network Working Group of The Internet Society, Inc.). In the case of “apply IPsec”, the SPD cache 60 is also accessed to determine the appropriate security association (SA) to use for the packet.

For inbound packet processing, the SPD cache is accessed to determine if the required IPsec processing was applied to the IPsec packet. For non-IPsec packets, the SPD cache 60 validates that the packet is permitted to traverse the internal network.

Although the example described two pairs of primary and secondary tables it is possible to use any number of primary and secondary table pairs.

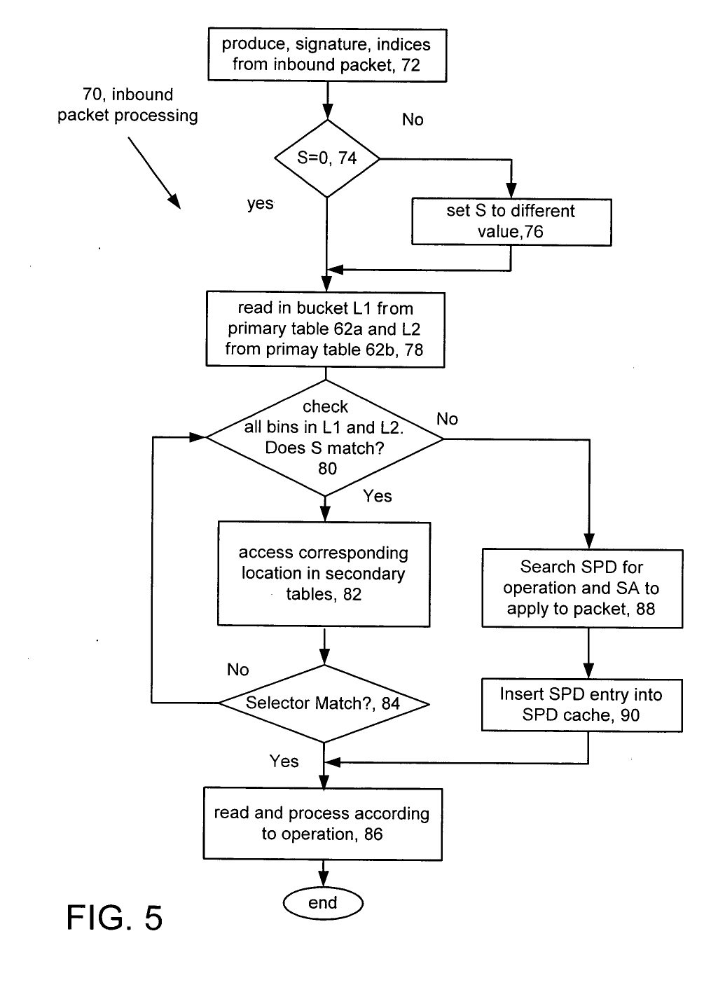

Referring to FIG. 5, exemplary inbound packet processing 70 using the SPD Cache 60 is shown. The cache 60 uses the IP packet selector from the inbound packet and hashing algorithm to produce 72 a signature (S), Index1 for table 1 (L1) and Index2 for table 2 (L2). The Index1 and Index2 are bucket indexes to primary table 1 and 2. The inbound packet processing 70 determines 74 if S equals zero. If S is equal to zero, the inbound packet processing 70 sets 76 S to another value such as one. A zero signature cannot be used since it means that the slot is empty and may be used for new entry. Inbound packet processing 70 reads 78 in bucket L1 from primary table 62a and bucket L2 from primary table 62b. The inbound packet processing 70 checks 80 all bins in buckets identified by indexes L1 and L2 for a match. If no match is found, inbound packet processing 70 goes to 88, otherwise inbound packet processing 70 continues with 82. For all signatures in buckets L1 and L2 that match S, inbound packet processing 70 checks 82 the corresponding location in the secondary table. The corresponding position can be found using the equation:
“U”*secondary entry size*bins per bucket+“B”*secondary entry size
where B is the bin location where the signature matched “S” and “U” is either L1 or L2 depending on which table has the signature that matched to “S.” The inbound packet processing 70 determines if the selector in the secondary table entry matches the IP packet selector above in 72 and match was successful so continue with 82. Otherwise the inbound packet processing 70 repeats 80 until either all the matching signatures are exhausted or a secondary table match is found. If all the signatures are exhausted the inbound packet processing 70 continues at 88. If a matching entry is found in one of the secondary tables, the inbound packet processing 70 performs 86 the operation indicated or optionally reads the flags for this packet entry.

The actions that are taken with the packet can be varied and are dependent on the operation. For instance, if the inbound operation indicates, “drop” the packet is dropped. If the inbound operation indicates, “bypass” then the packet is allowed to enter the network. If the inbound operation indicates, “apply IPsec security” the inbound packet processing 70 decrypts and authenticates the packet. Once this process is complete and successful, the decrypted packet is validated with the SPD cache to ensure proper IPsec processing occurred. The correct SA indexes are stored in the SPD cache 60. Inbound packets may be permitted through multiple tunnels. Thus, the secondary table entry has a number of separate tunnels, which are acceptable for packet reception. If the packet arrived down the wrong tunnel however the packet is dropped.

If all the signatures are exhausted the inbound packet processing 70 continues at 80 by searching 88 the security policy database to locate the proper operation for the packet and to locate the correct policies that relate to the inbound packet and inserts 90 the new SPD cache entry into the SPD cache. A technique to insert new SPD cache entries is described below. The process 70 will process the packet 86, as above.

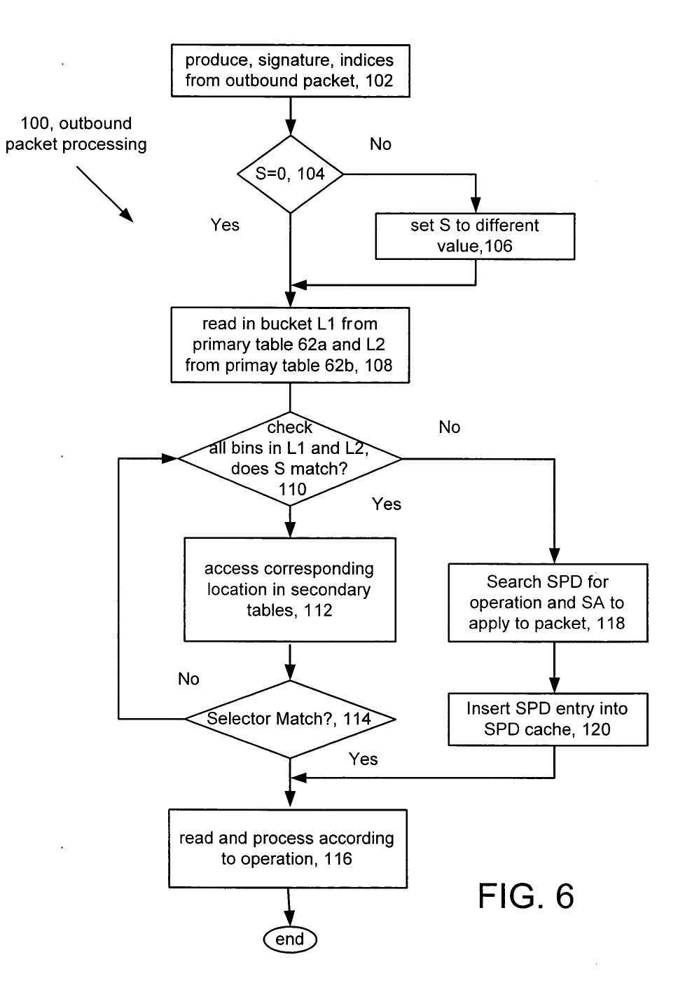

Referring now to FIG. 6, an example of outbound packet processing 100 using the SPD Cache 60 is shown. The outbound packet processing 100 uses the IP packet selector from the outbound packet and hash to produce 102 a signature (S), Index1 (L1) and Index2 (L2). Index1 and Index2 are bucket indexes to primary tables 62a and 62b. The outbound packet processing 100 determines 104 if “S” equals zero, and if so sets 106 “S” to another value such as one. A zero signature cannot be used since it indicates that the slot is empty and may be used for new entry. Outbound packet processing 100 reads 108 contents of bucket L1 from primary table 62a and contents of bucket L2 from primary table 62b. The outbound packet processing 100 checks 110 all bins in bucket L1 and L2 for a match. If no match is found, outbound packet processing 100 goes to 118, otherwise outbound packet processing 100 continues at 112.

For all signatures in buckets L1 and L2 that match S, outbound packet processing 100 checks 112 the corresponding location in the secondary table 64a or 64b. The corresponding position in the secondary table 64a or 64b can be found using the equation:
<U>*<secondary entry size>*<bins per bucket>+<B>*<secondary entry size>
where B is the bin location where the signature matched S and U is either L1 or L2 depending on which table contains the signature that matched S.

Outbound packet processing 100 determines 114 if the selector in the secondary table entry matches the IP packet selector in produced in 102. If matched, the process 100 performs the indicated operation or optionally reads flags for the packet and processes 116 the packet according to the operation or flags. Otherwise the outbound packet processing 100 repeats 110 until either all the matching signatures are exhausted or a secondary table match is found. If all the signatures are exhausted then outbound packet processing 100 continues with 118.

Outbound packet processing 100 processes 116 the packet according to the operation for this packet entry. If the outbound operation indicates drop, the packet is dropped. If the outbound operation indicates bypass, the outbound packet processing 100 lets the packet bypass IPsec encryption. If the outbound operation indicates apply IPsec security then the outbound packet processing retrieves the outbound SAs from SPD cache 60 and continues IPsec processing.

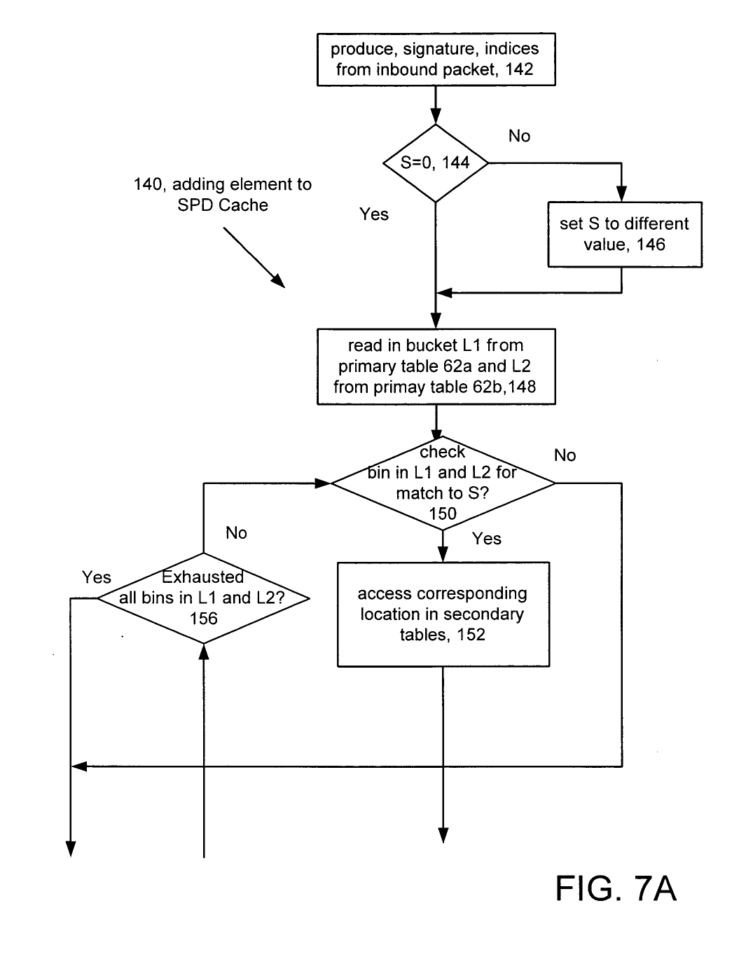

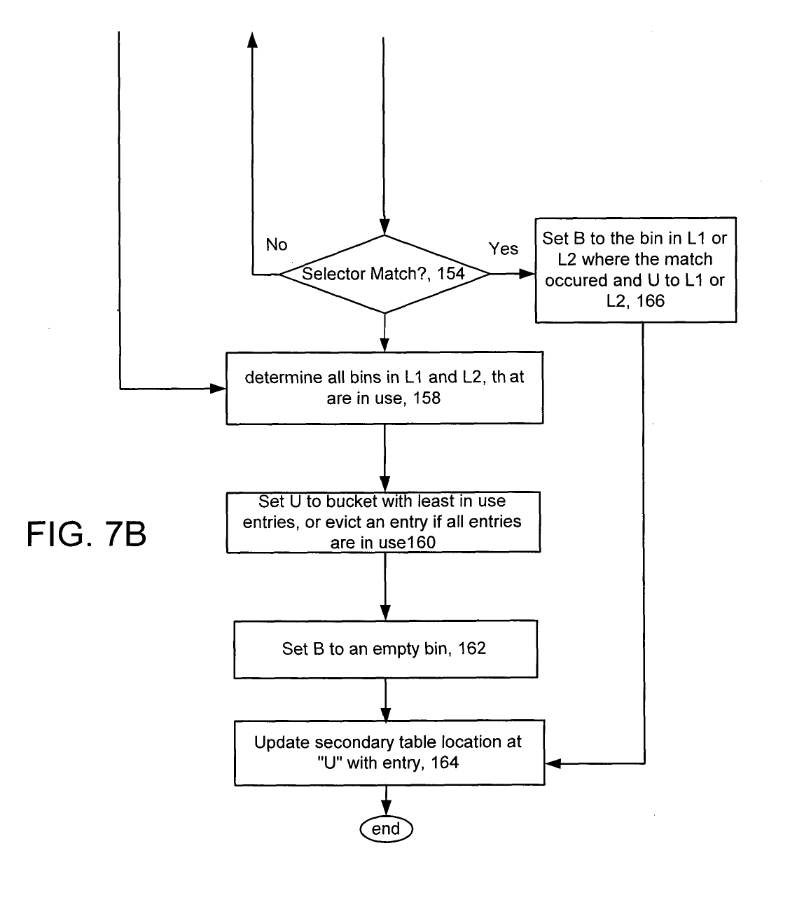

If all the signatures are exhausted or no match was found, the outbound packet processing 100 searches 118 the security policy database to locate the proper operation to perform on the outbound packet and finds the proper SAs that apply to the packet (if the operation is “apply IPsec security”). The outbound packet processing 100 inserts 120 the new SPD cache entry into the SPD cache 60 using the technique described in FIG. 7.

Referring to FIGS. 7A and 7B, a process 140 to add elements to the cache 60 is shown. The process 140 uses the IP packet selector and hashing algorithm to produce 142 a signature (S), Index1 (L1) and Index2 (L2). Index1 and Index2 are bucket indexes to primary table 62a and 62b. The process 140 determines 144 if “S equals zero” and if so, sets 146 “S” to another value such as one. A zero signature cannot be used since it indicates that the slot is empty and may be used for a new entry. The process 140 reads 148 in bucket L1 from primary table 62a and bucket L2 from primary table 62b. The process 140 checks 150 a bin in buckets L1 and L2 for a match. The process 140 then reads the corresponding 152 secondary table entry and determines if the selector matches 154 a selector that already exists in the secondary table 64a or 64b. If the selector is present, the process 140 will set 166 “B” to the bin in L1 or L2 where the match occurred and U to either L1 or L2. The process 140 will then 164 update the location with new information. If the selector is not present and 156 all bins in L1 and L2 were not exhausted, the process 140 checks 150 a next bin in buckets L1 and L2 for a match, and proceeds as above.

If the selector is not present and 156 all bins in L1 and L2 are exhausted, the process 140 checks 158 the number bins in L1 and L2 that are in use and sets 160 a value “U” to the bucket with the least number on in-use entries. It will be either L1 or L2. The process 140 sets 162 a value “B” to one of the empty bin entries in “U.” Empty bins are denoted by a 0 value. The process 140 updates 164 the secondary location given by the following:
“U”*secondary entry size*bins per bucket+“B”*secondary entry size

For hash deletions a process can zero the corresponding signature slot in the appropriate primary table. If the cache is full a cache victimization process would be used to determine which entries are removed from the cache, e.g., a LRU (least recently used) algorithm or other type could be used.

Advantages of this approach include obviating the need for expensive external hardware lookup devices. In particular when used with a device that can make parallel reads, the technique allows accesses to multiple primary tables via multiple independent read operations. Since the read operations are independent, there is no need to wait for a first read to complete before a second read is initiated. This permits excellent latency hiding in the microengines. Also, the technique is easily extensible so more primary and secondary tables can be added if they are needed.

The built-in collision capability of the technique allows more selectors to be stored in the cache, thus reducing the number of long SPD searches required to locate the correct SPD entry. The reduced searching requirements provide a concomitant increase in processing rates, while requiring use of fewer microengines to maintain line rates. It also minimizes bus usage between microengines and memory. These advantages permit better use of network processors and the busses connected to them. The cache quickly determines the security services afforded to the packet as well as the security associations (SA) that relate to the packet. Therefore, there is an advantage in adding caching for the security policy database entries. The cache minimizes the amount of searching required to locate an entry and is well suited for network processor designs.

A number of embodiments have been described. Nevertheless, it will be understood that various modifications may be made. Accordingly, other embodiments are within the scope of the following claims.

1. A security policy database cache comprises:
at least one primary table including signature values that indicate that a IPSec packet's security policy database (SPD) information may be in the cache; and
at least one secondary table including cache entries having a selector, flags, security association (SA) information and an operation to perform on the corresponding packet for which a cache lookup was made.

2. The security policy database cache of claim 1 wherein the at least one primary table resides in DRAM.

3. The security policy database cache of claim 1 wherein the at least one secondary table resides in SDRAM.

4. The security policy database cache of claim 1 wherein at least one primary table and the at least one secondary table resides in the same memory.

5. The security policy database cache of claim 1 wherein the at least one primary table and the at least on secondary table resides in shared memory accessible by engines of a network processor.

6. The security policy database cache of claim 1 wherein the at least one primary table is divided into a plurality of buckets and each bucket is subdivided into bins.

7. The security policy database cache of claim 1 wherein the cache has a one-to-one correlation between the at least one primary table location and the at least one secondary table.

8. The security policy database cache of claim 1 wherein the signature index for the first primary table is produced using an IP selector and either a hardware hash unit or a software hashing algorithm.

9. The security policy database cache of claim 8 wherein the IP selector can be either IPv4 or IPv6 and includes IP destination, IP source, IP protocol, IP source port, IP destination port.

10. The security policy database cache of claim 10 wherein when the at least one primary table is searched for a matching signature to a packet, and if no matching signature is found, the at least one secondary table is not accessed.

11. The security policy database cache of claim 10 wherein when the at least one primary table is searched for a matching signature to a packet, and a matching signature is found, the at least one secondary table is accessed.

12. The security policy database cache of claim 11 wherein if the selector match is successful flags and SA information are returned to a requesting device.

13. The security policy database cache of claim 1 wherein the at least one primary table is a first one of a plurality of primary tables and the at least one secondary table is a first one of a plurality of secondary tables.

14. The security policy database cache of claim 13 wherein when one of the plurality of primary tables is searched for a matching signature to a packet, and if no matching signature is found, the secondary table for the one of the plurality of primary tables is not accessed.

15. The security policy database cache of claim 14 wherein when one of the plurality of primary tables is searched for a matching signature to a packet, and a matching signature is found, the secondary table for the one of the plurality of primary tables is read and a selector is compared with the selector from the packet.

16. The security policy database cache of claim 14 wherein if the selector match is successful flags and security association (SA) information are returned to a requesting device.

17. A method comprises:
producing a signature of a packet and at least first and second indexes into corresponding first and second primary tables of a security database cache;
reading contents of a bucket from a first one of the primary tables and a bucket from a second one of the primary tables to determine whether either of the buckets have contents that match to the produced signature; and for a match,
determining if a selector in an entry in a secondary table matches a selector of the packet; and if a match
processing according to an operation indicated by the entry.

18. The method of claim 17 wherein processing comprises, processing the packet by reading flags for the packet entry to process the packet according to the flags.

19. The method of claim 17 wherein the cache uses the IP packet selector from a packet and hashing algorithm to produce the signature.

20. The method of claim 17 wherein the actions taken with the packet depend on the value of the flags and include dropping the packet if the flags indicate drop, bypass, and enter a secure network.

21. The method of claim 17 wherein the packets are incoming packets.

22. The method of claim 17 wherein the packets are outgoing packets.

23. The method of claim 17 wherein an entry is added to the security policy database cache.

24. The method of claim 17 wherein if the signatures are exhausted, the method further comprises:
searching a security policy database to locate the proper operation for the packet and to locate the correct security associations (Sas) to apply to the packet; and
inserting the located correct SA as a cache entry into a SPD cache.

25. The method of claim 17 wherein packet processing determines if the signature equals zero, and if zero, the packet processing sets the signature to another, non-zero value.

26. The method of claim 17 wherein the packet processing repeats until either all the matching signatures are exhausted or a secondary table match is found.

27. A computer program product residing on a computer readable medium for processing a packet comprises instructions to cause at least one processor to:
produce a signature of a packet and first and second indexes into corresponding first and second primary tables of a security database cache;
read contents of a bucket from a first one of the primary tables and a bucket from a second one of the primary tables to determine whether either of the buckets have contents that match to the produced signature; and for a match,
process according to an operation indicated by the entry.

28. The computer program product of claim 27 wherein processing comprises, processing the packet by reading flags for the packet entry to process the packet according to the flags.

29. The computer program product of claim 27 wherein the cache uses the IP packet selector from a packet and hashing to produce the signature.

30. The computer program product of claim 27 wherein the actions taken with the packet depend on the value of the flags and include dropping the packet if the flags indicate drop, bypass, and enter a secure network.

31. The computer program product of claim 27 wherein the packets are incoming packets.

32. The computer program product of claim 27 wherein the packets are outgoing packets.

33. The computer program product of claim 27 wherein an entry is added to the security policy database cache.

34. The computer program product of claim 27 wherein if all of the signatures are exhausted, the computer program product of claim 27 further comprises instructions to:
searching a security policy database to locate the proper operation for the packet and to locate the correct security associations (Sas) to apply to the inbound IPsec packet; and
inserting the located correct SA as a cache entry into a SPD cache.

35. The computer program product of claim 27 wherein packet processing determines if the signature equals zero, and if zero, the packet processing sets the signature to another, non-zero value.

36. The computer program product of claim 27 wherein the packet processing repeats until either all the matching signatures are exhausted or a secondary table match is found.

37. A network forwarding device comprising:
at least one physical interface;
a framer;
a network processor;
security policy database cache to provide data to the network processor when processing packets, the security policy database including:
at least one primary table including signature values that indicate that a packet's SPD information may be in the cache; and
at least one secondary table including cache entries having a selector, flags, SA information and an operation to perform on the corresponding packet for which a cache lookup was made; and
a switch fabric.

38. The device of claim 37 wherein the interface is a media access controller device.

39. The device of claim 37 further comprising SDRAM storing the at least one secondary table.

40. The device of claim 37 further comprising SRAM storing the at least one primary table.

41. The device of claim 37 further comprising local memory to store the at least one primary table.

42. The device of claim 37 further comprising scratchpad memory to store the at least one primary table.
